(19) United States
(12) Patent Application Publication
(10) Pub. No.: US 2007/0280870 A1
(43) Pub. Date: Dec. 6, 2007

(54) Process for preparation of nano-particulate mica

(75) Inventors: Radhakrishnan Subramaniam, Pune (IN); Subramanyam Santhanam, Pune (IN)

Correspondence Address: LADAS & PARRY, 26 WEST 61ST STREET, NEW YORK, NY, 10023, US

(73) Assignee: COUNCIL OF SCIENTIFIC AND INDUSTRIAL RESEARCH

(21) Appl. No.: 11/213,673

(22) Filed: Aug. 26, 2005

(30) Foreign Application Priority Data
Aug. 26, 2004 (IN) 1607/DEL/2004

(51) Int. Cl. C09C 1/00; C04B 14/20; C04B 14/04; C01B 33/26

(52) U.S. Cl. 423/328.3; 106/415; 106/417; 106/484; 423/328.1

(57) ABSTRACT

The present invention provides a method for the preparation of nano-particulate mica from the available mineral by polymerization of monomers which have large interaction with mica.

### FIELD OF THE INVENTION

The present invention relates to a process for the preparation of nano-particulate mica. In particular it provides a process for chemically reducing the particle size of naturally occurring mica mineral.

### BACKGROUND OF THE INVENTION

There have been several reports recently on nano-sized materials that exhibit different properties than normal large macro-crystalline materials (E. P. Gianellis, Adv. Mater. 1996, p. 29 to 35). Further, these particulate fillers have been used in plastics so as to make nano-composites having improved properties. Hence, there is a growing demand for downsizing of conventional fillers for plastics. Apart from the published literature on nano-size clay (L. V. Iterrante and L. A. Casper, Materials Chemistry, ACS 1995), There has been very little effort made on preparation of nano-particulate minerals such as mica, talc etc. Minerals such as mica and talc are extensively used as fillers for plastics in order to improve mechanical and electrical properties. The conventional method of grinding is used for converting these minerals to particulate form. However, methods such as grinding do not yield nano-size particles. The formation of nano-sized particles in such cases are achievable conventionally only by special chemical treatment. The nano-size clay is reported to be produced by exfoliation method after acid treatment. However, this method is not suitable for minerals such as mica since there is no effect on these minerals by the chemicals employed for downsizing clay. Hence, a method for preparation of nano-size particles of mica is important and necessary for use in plastics with improved performance.

### OBJECTS OF THE INVENTION

The main object of the present invention is to provide a process for preparation of nano-particulate mica.

### SUMMARY OF THE INVENTION

Accordingly, the present invention provides a process for the preparation of nano-particulate mica, which comprises adding naturally occurring mica mineral flakes to a high polar solvent in which a monomer is dissolved, and allowing the mica to soak, reacting the mixture of mica flakes and solvent with a reactant selected from a Group I or Group II metal salt containing halogen, oxygen or sulfur atoms, raising the temperature so as to react with the monomer and allowing the reaction to proceed for a time period in the range of 4 hr to 20 hr, precipitating the reacted mass in a solvent under high speed stirring, separating the powder particles and washing to give nano-particulate mica.

In one embodiment of the invention, the naturally occurring mica is selected from the group consisting of phlogopite, muscovite, chlorite and vermiculite.

In another embodiment of the invention, the naturally occurring mica is pulverized to a sieved mesh size of greater than 200 prior to addition to the high polar solvent.

In another embodiment of the invention, the high polar solvent used has dielectric constant in the range of 12 to 45 and solubility parameter between 9 and 14.

In another embodiment of the invention, the high polar solvent is selected from n-methyl pyrrolidone and di-n butyl amine.

In another embodiment, the monomer used has polar substituted aromatic groups and is selected from the group consisting of dichloro, dibromo or diiodo benzene, phenol, substituted phenol, chlorostyrene and alpha methyl styrene.

In yet another embodiment the concentration of the monomer is in the range of 30% to 90% of mica added in the solvent.

In another embodiment of the invention, the mica flakes are soaked in the high polar solvent for a time period in the range of 2 to 10 hr and at an elevated temperature.

In another embodiment the temperature of reaction is in the range of 60° C. to 190° C.

In another embodiment of the invention, the Group I or Group II metal salt is used in the form of a pre-mixed solution in methanol.

In another embodiment the solvent used for precipitation has solubility parameter in the range of 20 to 24.

### DETAILED DESCRIPTION OF THE INVENTION

The present invention provides a process for the preparation of nano-particulate mica, which comprises adding naturally occurring mica mineral flakes to a high polar solvent in which a monomer is dissolved. The mixture is allowed to soak and then reacted with a reactant selected from a Group I or Group II metal salt containing halogen, oxygen or sulfur atoms. The temperature is then raised to enable the reactant to react with the monomer and the reaction allowed to proceed for several hours, preferably 4 hr to 20 hr. The reacted mass is precipitated out in a solvent under high speed stirring and powder particles separated and washed to give nano-particulate mica.

The naturally occurring mica is selected from the group consisting of phlogopite, muscovite, chlorite and vermiculite. The mica is first pulverized to a sieved mesh size of greater than 200 prior to addition to the high polar solvent.

The high polar solvent used has dielectric constant in the range of 12 to 45 and solubility parameter between 9 and 14 and is preferably n-methyl pyrrolidone or di-n butyl amine. The monomer used has polar substituted aromatic groups and is selected from the group consisting of dichloro, dibromo or diiodo benzene, phenol, substituted phenol, chlorostyrene and alpha methyl styrene.

In yet another embodiment the concentration of the monomer is in the range of 30% to 90% of mica added in the solvent.

The mica flakes are soaked in the high polar solvent for a time period in the range of 2 to 10 hr and at an elevated temperature.

The temperature of reaction is in the range of 60° C. to 190° C. The Group I or Group II metal salt is used in the form of a pre-mixed solution in methanol. The solvent used for precipitation has solubility parameter in the range of 20 to 24.

In a feature of the present invention, the nano-particulate mica can be used as additive with various thermoplastics typically polypropylene without further treatment which leads to tremendous improvement of properties as compared to conventional mica filled composites.

The process of the present invention is described hereinbelow with examples, which are illustrative and should not be construed to limit the scope of the invention in any manner.

### EXAMPLE-1

Phlogopite mica (1 g) having sieved mesh size of 350 was dropped in n-methyl pyrrolidone 100 ml in which were dissolved 1,4-dibromobenzene (7.08 g) heated to temperature of 80-90° C. and stirred for 12 hours to form reaction mixture (I). Sodium sulfide (7.2 g) was dissolved separately in 40 ml of methanol and the solution added to the reaction mixture (I) and kept at 100 oC for two hr then the temperature was raised to 180 oC. The reaction was allowed to proceed for 12 hr under reflux conditions. The reaction mixture was then cooled to room temperature and the mass precipitated in 300 ml of methanol, filtered, washed with water and then methanol and dried at 50 C for few hours to obtain nano-particulate mica. The characteristics of this mica are given in Table-1.

### EXAMPLE-2

Muscovite mica (2 g) having 350 mesh size, was dropped in n-methyl pyrrolidone 100 ml in which were dissolved 1,4-dibromobenzene (7.08 g) heated to temperature of 80-90° C. and stirred for 12 hours to form reaction mixture (I). Sodium sulfide (7.2 g) was dissolved separately in 40 ml of methanol and the solution added to the reaction mixture (I) and kept at 100° C. for two hr then the temperature was raised to 180° C. The reaction was allowed to proceed for 12 hr under reflux conditions. The reaction mixture was then cooled to room temperature and the mass precipitated in 300 ml of methanol, filtered, washed with water and then methanol and dried at 50° C. for few hours to obtain nano-particulate mica. The characteristics of this mica are given in Table-1.

### EXAMPLE-3

Muscovite mica (1.25 g) was added to a flask containing 1.25 ml of di-n-butyl amine, 1 ml of methanol and 0.048 g of copper bromide and oxygen is bubbled in the suspension with vigorous stirring at 25° C. To this suspension, 3.05 g of 2,6-dimethylphenol dissolved in 9 ml of toluene is added over a 10 minute period. The stirring is continued for around 1 hour after which the reaction is quenched by the addition of 1 ml of glacial acetic acid. The reaction mass is precipitated by adding 200 ml of methanol. The precipitate is filtered, washed thoroughly with methanol and dried at 50° C. for few hours to obtain nano-particulate mica. The characteristics of this mica are given in Table-1.

TABLE 1
Comparison of particle size and X-ray diffraction features
for nano-particulate mica prepared by process described

| | Nano-particle Mica sample | | | |
|---|---|---|---|---|
| | | | | Unidentified |
| | Example 1 | Example 2 | Example 3 | Mica |
| Particle Size Nm | 13 | 22 | 23 | >40 |
| X-ray Peak | | | | |
| intensity at 2θ | | | | |
| 28.61° | 231 | — | — | 2163 |
| 26.87° | — | 212 | 687 | 2169 |
| 45.49° | — | 137 | 372 | 1231 |

It can be seen by comparing the values of particle size and other data on X-ray diffraction scans given in the above Table-1 that there is a large decrease in the intensity values suggesting drastic change in crystalline order as well as the crystallite size and that the nano-particulate mica can be formed by the process described in the present invention.

The main advantage of the present invention is that it provides a simple method of preparation of mica particles occurring naturally without the use of harsh environment such as strong acids or high pressures for down sizing the mineral.

We claim:

1. A process for the preparation of nano-particulate mica, which comprises adding naturally occurring mica mineral flakes to a high polar solvent in which a monomer is dissolved, and allowing the mica to soak, reacting the mixture of mica flakes and solvent with a reactant selected from a Group I or Group II metal salt, raising temperature so as to react with the monomer and allowing the reaction to proceed for a time period in the range of 4 hr to 20 hr, precipitating a reacted mass in a solvent under high speed stirring, separating powder particles so obtained and washing to obtain nano-particulate mica.

2. A process as claimed in claim 1 wherein the naturally occurring mica is selected from the group consisting of phlogopite, muscovite, chlorite and vermiculite.

3. A process as claimed in claim 1 wherein, the high polar solvent used has dielectric constant in the range of 12 to 45 and solubility parameter between 9 and 14.

4. A process as claimed in claim 1, wherein the monomer used has polar substituted aromatic groups and is selected from the group consisting of dichloro benzene, dibromo benzene, diiodo benzene, phenol, substituted phenol, chlorostyrene and alpha methyl styrene.

5. A process as claimed in claim 1, wherein the compatibilizer is chosen from a branched polymer containing ethylene and octene units in the ratio of 0.1% to 1%.

6. A process as claimed in claim 1, wherein the second reactant used is group I or II metal salt containing halogen, oxygen or sulfur atoms.

7. A process as claimed in claim 1, wherein the temperature of reaction is in the range of 60° C. to 190° C.

8. A process as claimed in claim 1, wherein the solvent used for precipitation has solubility parameter in the range of 20 to 24.

9. A process as claimed in claim 2 wherein the naturally occurring mica is pulverized to a sieved mesh size of greater than 200 prior to addition to the high polar solvent.

10. A process as claimed in claim 1 wherein the high polar solvent is selected from n-methyl pyrrolidone and di-n butyl amine.

11. A process as claimed in claim 1 wherein the concentration of the monomer is in the range of 30% to 90% of mica added in the solvent.

12. A process as claimed in claim 1 wherein the mica flakes are soaked in the high polar solvent for a time period in the range of 2 to 10 hr and at an elevated temperature.

13. A process as claimed in claim 1 wherein the Group I or Group II metal salt is used in the form of a pre-mixed solution in methanol.
